(19) United States
(12) Patent Application Publication
(10) Pub. No.: US 2004/0195405 A1
(43) Pub. Date: Oct. 7, 2004

(54) Voltage and current display for electrostatic spray gun

(76) Inventor: Craig P Healy, Wyoming, MN (US)

Correspondence Address: Douglas B Farrow, Intellectual Property Counsel, Graco Minnesota Inc, P O Box 1441, Minneapolis, MN, 55440-1441, US

(21) Appl. No.: 10/487,198

(22) PCT Filed: Sep. 6, 2002
(86) PCT No.: PCT/US02/28525

Related U.S. Application Data
(60) Provisional application No. 60/317,807, filed on Sep. 6, 2001.

(51) Int. Cl. B05B 5/00; F23D 11/32

(52) U.S. Cl. 239/690; 239/690.1

(57) ABSTRACT

A display (K) on the back (14) of the spray gun (12) informs the electrostatic gun operator of the tip voltage and tip current This information is used to quickly verify system operation and paint resistivity. The painter can monitor the light bars (K) for proper operation while painting.

### TECHNICAL FIELD

This application claims the benefit of U.S. application Ser. No. 60/317,807, filed Sep. 6, 2001.

### BACKGROUND ART

Electrostatic spray guns have proven to be useful tools for efficient application of paints and coatings. Because of Faraday cage and other effects, a gun may not always spray at its desired voltage. Some older gun models had wall-mounted voltage and current displays that were difficult or impossible to see while painting.

### DISCLOSURE OF THE INVENTION

A display on the back of the spray gun informs the electrostatic gun operator of the tip voltage and tip current. This information is used to quickly verify system operation and paint resistivity. The painter can monitor the light bars for proper operation while painting.

The electrostatic guns have a PCB assembly potted into the smart handle. This PCB assembly is connected to the electrostatic power supply through a flex cable. The PCB has a microprocessor that is programmed to senses both tip current and power supply reference voltage. The microprocessor then calculates tip voltage based on these inputs. Tip current and tip voltage are then displayed on the two row by nine segment LED light bar display. The top bar is tip voltage; the bottom bar is tip current. Due to power supply operation, as tip current increases, tip voltage decreases.

This light bar display allows the operator to easily view, at a glance, the tip voltage and current level as they are spraying. Since light bars are used rather than a digital display, this information can be viewed without taking the focus off painting. This information can be used as an aid for training painters as well as quickly verifying system setup and paint resistivity.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the rear of a spray gun having the display of the instant invention.

FIG. 2 is a schematic of the circuitry for the display.

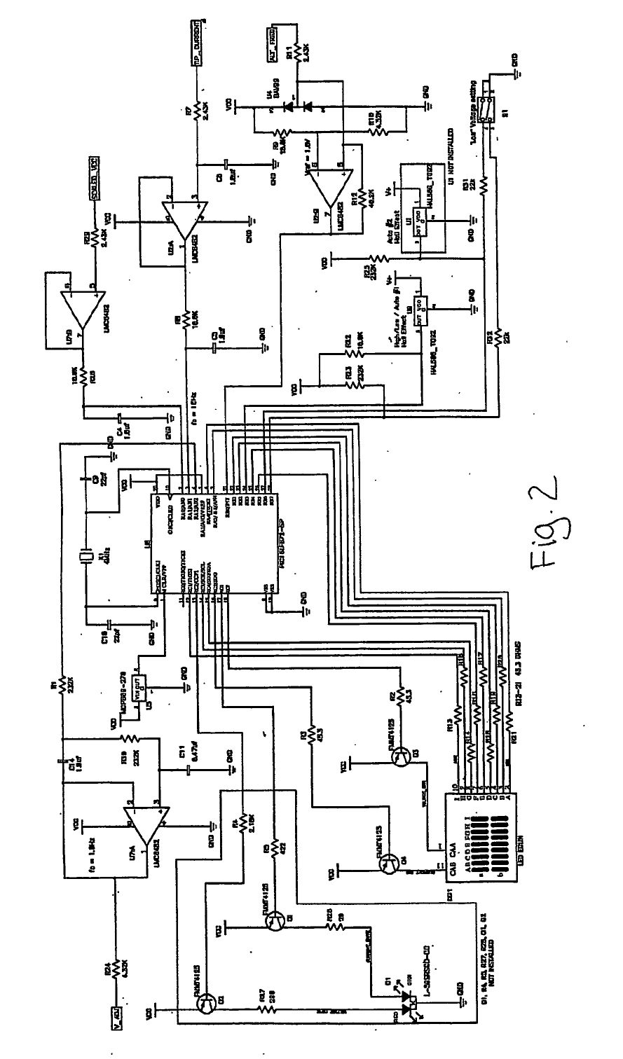

### BEST MODE FOR CARRYING OUT THE INVENTION

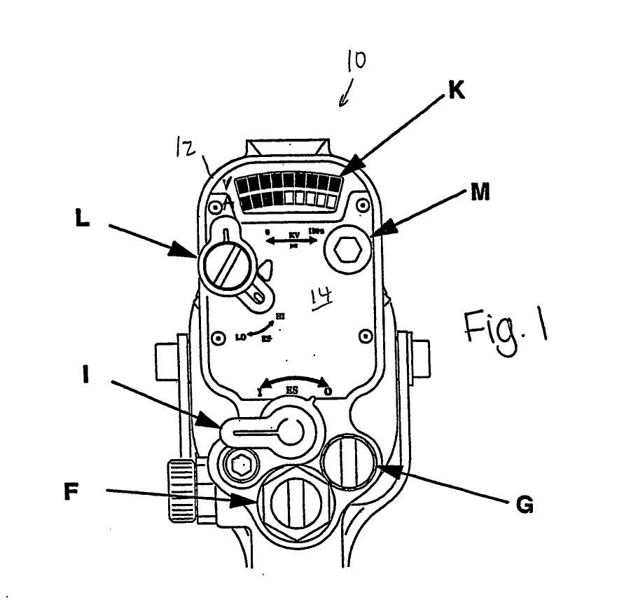

The instant invention, generally designated 10, is shown in FIG. 1 is shown on an electrostatic spray gun 12 having a rear end (which faces the operator) 14. Located thereon are a fluid adjustment valve F which adjusts fluid needle travel. A Fan air adjustment valve G adjusts fan size and shape. An ES ON/OFF switch I turns electrostatics ON or OFF. A voltage/current display K shows voltage (V) and current (A) with a green color indicating a spray condition and yellow/red indicating that troubleshooting should be done. An ES HI/LO switch L sets voltage to HI or LO factory settings and one can remove plug M to adjust to 4 settings.

It is contemplated that various changes and modifications may be made to the voltage and current display for electrostatic spray gun without departing from the spirit and scope of the invention as defined by the following claims.

1. In an electrostatic spray gun producing a tip voltage and current flow and having an operator-facing rear end, the improvement comprising a visual indicator of at least one of said tip voltage and spraying current.

2. The electrostatic spray gun of claim 1 wherein said visual indicator comprises a bar display.

3. The electrostatic spray gun of claim 2 wherein said visual indicator comprises a two row LED array showing both tip voltage and spraying current.
